(19) United States
(12) Patent Application Publication
(10) Pub. No.: US 2026/0320364 A1
(43) Pub. Date: Oct. 15, 2026

(54) Virtual Batches in Non-Causal Large Language Model Inferences

(71) Applicant: Google LLC, Mountain View, CA (US)

(72) Inventors: Michael Christian Butler, Palo Alto, CA (US); Jingtao Wang, Pittsburgh, PA (US)

(73) Assignee: Google LLC, Mountain View, CA (US)

(21) Appl. No.: 19/696,173

(22) Filed: Jun. 2, 2026

(51) Int. Cl. G06N 3/0499; G06F 16/3329

(52) U.S. Cl. CPC G06N 3/0499; G06F 16/33295

(57) ABSTRACT

This document describes systems and techniques directed at virtual batches in non-causal large language model (LLM) inferences. An LLM generates a plurality of tokens. The plurality of tokens includes a prefix sequence. The LLM generates a dependency map. The dependency map includes one or more index markers for each of the plurality of tokens and a correlation marker for each of the one or more index markers. The LLM generates a plurality of virtual batches based on the dependency map. Generating the plurality of virtual batches may include applying an attention mask having a non-causal mask portion corresponding to the prefix sequence. Each of the plurality of virtual batches includes a discrete inference. The LLM selects one or more of the plurality of virtual batches as a final inference.

### CROSS-REFERENCE TO RELATED APPLICATIONS

This present application relates to International Patent Application No. PCT/US 2024/062418, filed Dec. 31, 2024, the entire content of which is hereby incorporated by reference herein.

### BACKGROUND

Large language models (LLMs) provide predictive outputs (“inferences”) based on parsing an input, such as a user text input, an audio input, a video input, an image input, etc. Often, the inferences are sequentially generated, meaning each prediction fragment (“token”) proceeds from the prior token. In other cases, such as with non-causal or prefix language models, an initial sequence of tokens is processed simultaneously, allowing tokens to bidirectionally attend to one another. Traditional techniques often limit inference optimization, which has led to the use of batches in inferences. Batches are concurrently generated inferences, which can be based on a common input, disparate inputs, or a combination of both. Each batch represents a discrete inference from the LLM. Multiple inference batches are computationally expensive, and the simultaneous processing of non-causal sequences further compounds this expense, making batch-inferencing LLMs cumbersome or computationally prohibitive to deploy on consumer computing devices.

### SUMMARY

This document describes systems and techniques directed at virtual batches in non-causal large language model (LLM) inferences. An LLM, at least partially deployed on an electronic device, generates a plurality of inference tokens. The plurality of inference tokens includes a prefix sequence. The inference tokens can be based on a same input, different inputs, or a mixture of both. The LLM generates a dependency map for the plurality of inference tokens. The dependency map indicates sequential or otherwise logical dependence of each inference token. The LLM can further generate a plurality of virtual batches based on the dependency map. In some aspects, generating the plurality of virtual batches includes applying an attention mask having a non-causal mask portion corresponding to the prefix sequence. The plurality of virtual batches may include one or more masked markers indicating positions in one or more of the plurality of virtual batches that lack an active token reference for a respective virtual batch.

In aspects, an electronic device is disclosed. The electronic device includes one or more processors and a memory storing instructions. The instructions, when accessed by the one or more processors, cause the one or more processors to generate, using an LLM, a plurality of tokens. The plurality of tokens includes a prefix sequence. The instructions further cause the one or more processors to generate a dependency map. The dependency map includes one or more index markers for each of the plurality of tokens. The dependency map further includes a correlation marker for each of the one or more index markers. The instructions further cause the one or more processors to generate, based on the dependency map, a plurality of virtual batches. Each of the plurality of virtual batches includes a discrete inference. The instructions further cause the one or more processors to select one or more of the plurality of virtual batches as a final inference.

In aspects, a method is disclosed. The method includes generating, with an LLM, a plurality of tokens. The plurality of tokens includes a prefix sequence. The method further includes generating, by the LLM, a dependency map. The dependency map includes one or more index markers for each of the plurality of tokens. The dependency map further includes a correlation marker for each of the one or more index markers. The method further includes generating, based on the dependency map, a plurality of virtual batches. Each of the plurality of virtual batches includes a discrete inference. The method further includes selecting, by the LLM, one or more of the plurality of virtual batches as a final inference.

In aspects, a non-transitory, computer-readable medium is disclosed. The non-transitory, computer-readable medium includes instructions that, when accessed by one or more processors, cause the one or more processors to generate, using an LLM, a plurality of tokens. The plurality of tokens includes a prefix sequence. The instructions further cause the one or more processors to generate, by the LLM, a dependency map. The dependency map includes one or more index markers for each of the plurality of tokens. The dependency map further includes a correlation marker for each of the one or more index markers. The instructions further cause the one or more processors to generate, based on the dependency map, a plurality of virtual batches. Each of the plurality of virtual batches includes a discrete inference. The instructions further cause the one or more processors to select one or more of the plurality of virtual batches as a final inference.

In aspects, a computer program product is disclosed. The computer program product includes a memory storing instructions that, when accessed by one or more processors, cause the one or more processors to generate, using an LLM, a plurality of tokens. The plurality of tokens includes a prefix sequence. The instructions further cause the one or more processors to generate a dependency map. The dependency map includes one or more index markers for each of the plurality of tokens. The dependency map further includes a correlation marker for each of the one or more index markers. The instructions further cause the one or more processors to generate, based on the dependency map, a plurality of virtual batches. Each of the plurality of virtual batches includes a discrete inference. The instructions further cause the one or more processors to select one or more of the plurality of virtual batches as a final inference.

This Summary is provided to introduce simplified concepts for virtual batches in non-causal large language model inferences, which are further described below in the Detailed Description and are illustrated in the Drawings. This Summary is intended neither to identify essential features of the claimed subject matter nor for use in determining the scope of the claimed subject matter.

### BRIEF DESCRIPTION OF THE DRAWINGS

The details of one or more aspects of systems and techniques for virtual batches in non-causal large language model inferences are described in this document with reference to the following drawings:

FIG. 1 illustrates an example environment in which techniques for virtual batches in non-causal large language model inferences can be implemented;

FIG. 2 illustrates an example of an electronic device of FIG. 1 for implementing virtual batches in non-causal large language model inferences;

FIGS. 3A-3C illustrate example dependency map arrays for implementing virtual batches in non-causal large language model inferences;

FIGS. 4A-4C illustrate example virtual batch generations with masking;

FIG. 5 illustrates an example trainer for an LLM, such as one used in virtual batches in non-causal large language model inferences;

FIG. 6 illustrates an example transformation in a language space of an input tensor component;

FIG. 7 illustrates an example method for implementing virtual batches in non-causal large language model inferences; and

FIG. 8 illustrates an example method for implementing virtual batches in non-causal large language model inferences.

The use of same numbers in different instances may indicate similar features or components.

### DETAILED DESCRIPTION

### Overview

The proliferation of artificial intelligence (AI), particularly large language models (LLMs), has revolutionized personal digital assistance, automation, novel code generation, and other areas of modern computing. The development of LLM use cases has resulted in a need for better predictions and inferences from LLMs. Traditionally, an LLM parses an input prompt and produces an output (prediction, inference, etc.). One way to improve the output of the LLM is to generate multiple inferences/outputs from one or more inputs (one or more text inputs, one or more image inputs, a mixture of text and image inputs, etc.). Each of the multiple inferences can be discrete, resulting in a plurality of inferences from which the LLM can choose as a final inference/output. In some cases, each of the plurality of inferences includes the one or more inputs. However, this methodology results in a much higher computational cost than simply generating a single inference/output. This increased computational cost (processor time/cycles, memory usage, cache usage, etc.) can prove prohibitive on many electronic devices (mobile electronic devices, smartphones, virtual reality (VR) or augmented reality (AR) goggles, smart watches, etc.).

With the increased utility and functionality of LLMs, relegating more robust embodiments (e.g., the LLM employing multiple batches for inference generation) to higher-resource computing devices denies most users from leveraging the increased capabilities of modern LLMs. For example, an LLM including generating multiple inference batches that, due to the computational cost of generating and maintaining the multiple inference batches, can only be deployed on a server and may not be fully accessible to a user with a smartphone that is not connected to the server. In another example with the LLM including generating multiple inference batches that can only be deployed on the server, the user with the smartphone can connect to the server, but the increased processing time/computational cost over a traditional LLM can result in a poor user experience, a drop in functionality, or other undesirable outcomes. In some instances, the act of generating and/or parsing multiple inference batches becomes overly computationally costly before sufficient advantage can be realized over traditional LLM processing. This computational bottleneck is compounded when using non-causal prefix language models, which require an entire sequence of input tokens to be processed simultaneously.

Consider a team of detectives building a physical evidence board to solve a complex case. To establish the foundational facts, the detectives cannot merely read the initial clues sequentially; they pin all the foundational evidence to the center of the board and run strings to connect every single clue to every other clue simultaneously, gaining a holistic understanding of the starting point of the case. Once this foundation is established, the detectives split up to explore multiple, diverging theories. They begin adding new deduction notes to the board, one step at a time. Instead of buying a completely separate evidence board for each detective to work on—which would waste physical space and require manually duplicating the complex web of foundational evidence—all the detectives pin their interleaved notes to the exact same original board. To keep their distinct theories from getting mixed up and cross-contaminating, they use a centralized index ledger that maps out exactly which logical path of notes belongs to which theory, allowing them to actively ignore notes from unrelated paths. This allows the team to independently branch off and explore dozens of theories in parallel on a single shared board.

In this analogy, the team of detectives represents a large language model (LLM). The foundational evidence where all clues are interconnected simultaneously represents a prefix sequence processed by a non-causal language model, where tokens bidirectionally attend to one another (e.g., using a square attention mask). The separate, unpurchased evidence boards represent computationally expensive physical batches duplicated in a cache memory. The single shared board holding all the interleaved deduction notes represents a single physical batch containing a plurality of virtual batches. The new deduction notes added one step at a time represent discrete inferences decoded auto-regressively (e.g., using a triangular causal mask). In this analogy, the centralized index ledger operates similarly to a dependency map. Finally, actively ignoring notes from unrelated paths represents the application of masked markers to prevent cross-contamination. This dynamic virtual batching illustrates how a shared dependency map can logically isolate and track multiple discrete inferences within the same physical memory space, eliminating the need to exhaust system resources by physically duplicating non-causal prefix sequences.

This document describes techniques and systems for virtual batches in non-causal large language model inferences. The techniques and systems use a generated dependency map to order and relate a plurality of tokens, which may include a prefix sequence. A plurality of virtual batches is generated based on the dependency map, and generating the plurality of virtual batches may include applying an attention mask having a non-causal mask portion corresponding to the prefix sequence. Each of the plurality of virtual batches represents, in aspects, a discrete inference. The LLM selects one or more of the plurality of virtual batches as a final prediction. In aspects, the final prediction is configured for output.

Tokens, as referred to herein, may include input tokens (e.g., prompt embeddings), inference tokens generated by the LLM, soft tokens generated by an encoder, or any combination thereof. In some examples, the tokens are in a text form (e.g., a word, a part of grammar, a word fragment). In some examples, the tokens are a mathematical construct (e.g., a tensor) in a language space. In aspects, the tokens can be referred to as embeddings. In some examples, the input is not a text input (a sound input, an image input, a video input, a robotics motion input, etc.). In such examples, the tokens can be soft tokens. For example, the prefix sequence may include a plurality of soft tokens generated by an encoder (e.g., a bidirectional transformer) from a multimodal input. In some examples, soft tokens are tokens that are embedded but at least in part dynamic. In some examples, soft tokens are tokens that have additional labels, tags, information, etc.

The generation of the dependency map, in aspects, may be configured to use fewer computational resources than generating separate, physical batches. For example, a plurality of physical batches each occupy space on a memory, such as a cache memory, which is of a finite size. A plurality of virtual batches, in some examples, are mapped from a single physical batch or a plurality of physical batches with a dimensionality less than the dimensionality of the mapped plurality of virtual batches. The single physical batch occupies less cache space than were it to be separated into several physical batches. In some examples, the dependency map includes more than one physical batch, but at least one of the more than one physical batches includes more than one virtual batch and still represents a savings in resources. Furthermore, a virtual batch relationship corresponding to the plurality of virtual batches for each of the plurality of tokens may be tracked, at least in part, through a feed-forward network (FFN) layer of the LLM.

According to some examples, the virtual batches are not generated by construction but rather are logically extrapolated from the dependency map. In this way, the dependency map can still leverage the advantage of multiple inferences without simultaneously incurring the resource/computational cost of using multiple inferences. Advantages of employing virtual batches in non-causal LLM inferences include lower computational cost, lower memory usage, and the ability to deploy a multiple-inference model on less resource-heavy devices, such as a smartphone. Additionally, computational constraints associated with prefix language models may be mitigated by processing the prefix sequence in a plurality of chunks, for example using a respective square mask for each chunk, providing a hybrid prefix language model architecture.

In some aspects, generating the attention mask for the non-causal prefix sequence includes establishing a mask configuration across the prefix sequence. For example, the attention mask for one or more prefix tokens within a same prefix sequence can be configured to be identical or substantially similar to the attention mask of the last (e.g., terminal) prefix token of that prefix sequence. In practice, the attention mask may allow the one or more prefix tokens within the same prefix sequence to function as if causally generated. This identical or substantially similar mask profile may allow the virtual batch framework to align a bidirectional prefix attention with the downstream auto-regressive decoding phase, which may have the desirable effect of streamlining dependency mapping and reducing execution overhead during runtime mask generation operations.

### Operating Environment

The following discussion describes operating environments. The following discussion also describes techniques that may be employed in the operating environments. Various devices or systems in which components of the operating environments can be embodied are also described. In the context of the present disclosure, reference is made to the operating environments by way of example only.

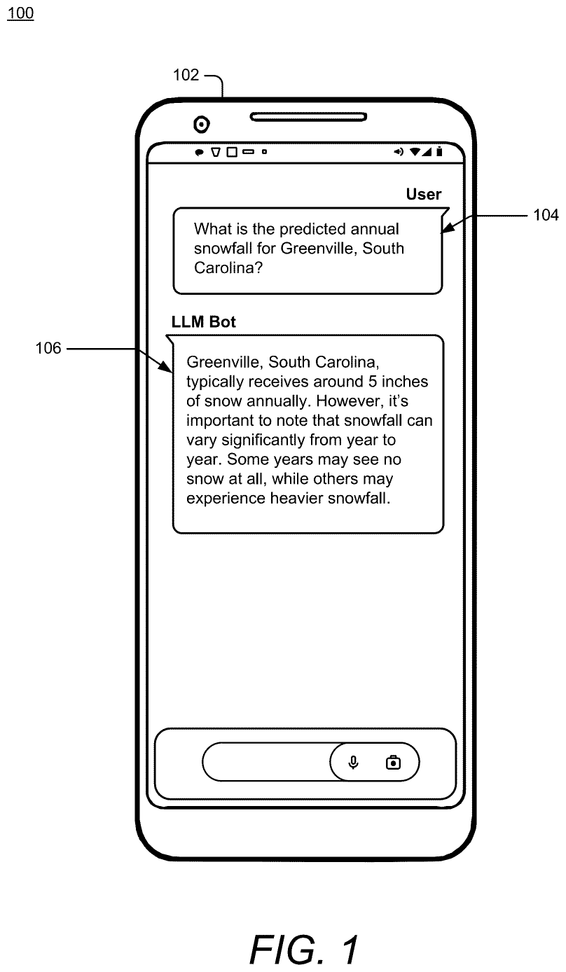

FIG. 1 illustrates an example environment 100 in which techniques for virtual batches in non-causal large language model inferences can be implemented. Generally, the environment 100 includes an electronic device 102. The electronic device 102 in the example pictured is a smartphone. Other electronic devices can be used equivalently. The electronic device 102 includes an instantiated LLM (not pictured). An input can be given to the LLM, such as an input prompt 104. The input prompt 104 is illustrated in FIG. 1 as a user input prompt. According to some examples, the input prompt 104 can be the product of a machine or machine algorithm. The input prompt 104 is illustrated as a text input. Other input types may be used equivalently. The other input types can include, but are not limited to, an audio input, a video input, an image input, or a robotics motion input. The input prompt 104 can be processed by an encoder. The encoder can generate a plurality of soft tokens based on the input prompt 104. The plurality of soft tokens can form a prefix sequence for the LLM. The LLM, in aspects, can provide a response 106.

The electronic device 102, in some examples, can be an assistant device. The assistant device can be an AI assistant, a home hub device, an AI agent, etc. The electronic device 102 can be a home automation controller. The home automation controller can be a controller for an alarm system, a thermostat, a lighting system, a door lock, motorized doors, etc. The electronic device 102 can be a gaming device. The gaming device can be a gaming system, a gaming controller, a data glove, etc. The electronic device 102 can be a communication device. The communication device can be a smart phone, a cellular phone, a mobile phone, a wireless phone, a portable phone, or a radio telephone. The electronic device 102 can be a wearable device. The wearable device can be a smart watch, smart glasses, earbuds, a smart helmet, a VR headset, AR goggles, a smart ring, etc. The electronic device 102 can be a vehicle. The vehicle can be a car, an electric scooter, an automated vehicle, etc. The electronic device 102 can be another computing device. The computing device can be a tablet computer, a phablet computer, a notebook computer, a laptop computer, etc. As another example, the electronic device 102 with an assistant application or program may audibly convey information to a user. In some implementations, a battery management system audibly conveys notification information to the user. The battery management system may list actions the user may take. The actions may include ordering new batteries or obtaining disposal information. In some implementations, the electronic device 102 listens for a response from the user. The response from the user can be a user selection of one or more of the listed actions. The electronic device 102 may respond accordingly. For example, the electronic device 102 can obtain and audibly convey disposal options to the user.

In some examples, the response 106 is based on data stored in a memory of the electronic device 102. According to some examples, the response 106 is based on one or more capabilities of the electronic device 102. In some examples, the response 106 is based on data stored remotely from the electronic device 102. The data can be stored on a remote server connected via a wireless communications link, the internet, etc. In some examples, the response 106 is produced using only resources of the electronic device 102. The resources can include one or more processors of the electronic device 102, the memory of the electronic device 102, etc. The response 106 can be produced using resources of a remote device. The response 106 can be produced using resources of the electronic device 102 and the remote device.

In aspects, the response 106 is based on one or more of a plurality of inferences. The plurality of inferences can be generated by the LLM based on the input prompt 104. The plurality of inferences, in aspects, can be a plurality of virtual batches. The plurality of virtual batches can be generated from a dependency map, as outlined in this disclosure. Generating the virtual batches can be performed by logical extrapolation. The generating can be performed without generating physical batches. Generating the plurality of virtual batches may include applying an attention mask. The attention mask can include a non-causal mask portion. The non-causal mask portion can correspond to the prefix sequence. The non-causal mask portion can be, for example, a square attention mask. The square attention mask can configure each token of the prefix sequence to attend to every other token of the prefix sequence.

The attention mask can further include a causal mask portion. The causal mask portion can correspond to one or more subsequent tokens. The one or more subsequent tokens can be generated auto-regressively after the prefix sequence. The dependency map includes one or more index markers for each of a plurality of tokens. The dependency map includes a correlation marker for each of the one or more index markers. The plurality of tokens, in aspects, are part of the generated plurality of inferences. The response 106 is based on one of the plurality of virtual batches. The one of the plurality of virtual batches can be selected by the LLM. In some examples, the LLM compares the plurality of virtual batches. The LLM can base the selection on the comparison. In some examples, the response 106 is based on more than one selection of the plurality of virtual batches. In some examples, operations are performed on the selected virtual batch. The operations can transform the selected virtual batch into the final form of the response 106.

### Example Devices

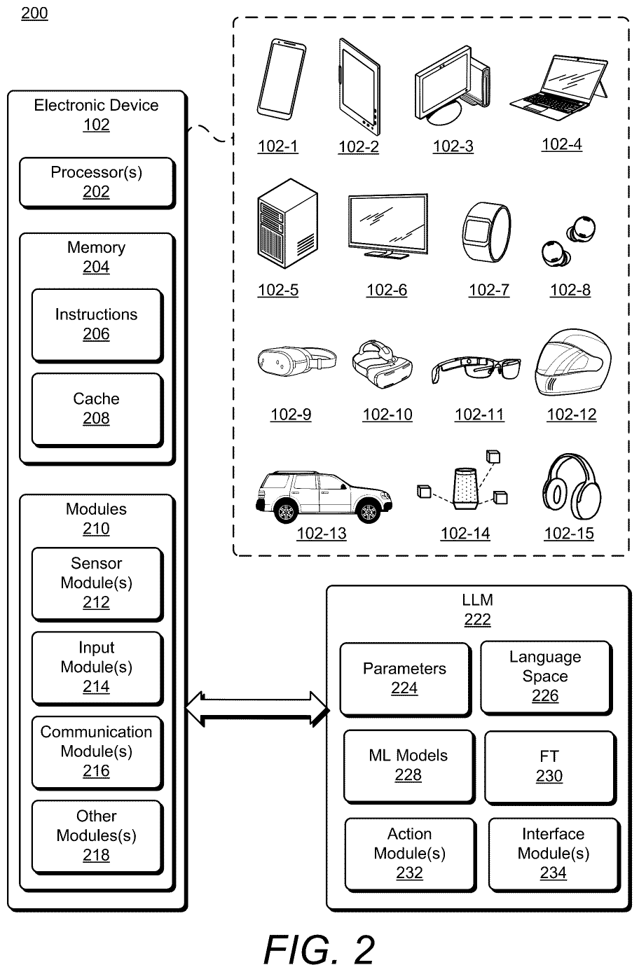

FIG. 2 illustrates an example of an electronic device 102 of FIG. 1 for implementing virtual batches in non-causal large language model inferences. Examples of the electronic device 102 include a smartphone 102-1, a tablet device 102-2, a desktop computer 102-3, and a laptop computer 102-4. The electronic device 102 can be a server 102-5. The server 102-5 can include a server array. The electronic device 102 can be a smart monitor or TV 102-6, a smartwatch 102-7, or earbuds 102-8. The earbuds 102-8 can be true-wireless earbuds. The electronic device 102 can be VR goggles 102-9, an AR headset 102-10, smart-glasses 102-11, or a smart-helmet 102-12. The electronic device 102 can be a smart vehicle 102-13, a home hub device 102-14, or headphones 102-15. Although not shown, the electronic device 102 may also be implemented as a mobile communication device, a client device, or a home automation and control system. The electronic device 102 may be an entertainment system, a personal media device, or a health monitoring device. The electronic device 102 may be a drone, a camera, or an Internet home appliance. The Internet home appliance can be capable of wireless Internet access and browsing. The electronic device 102 may be an IoT device, or a security system. Note that the electronic device 102 can be wearable, non-wearable but mobile, or relatively immobile. For example, the relatively immobile device can be an appliance. The electronic device 102 may include components or interfaces omitted from FIG. 2 for the sake of clarity or visual brevity.

As illustrated, the electronic device 102 includes one or more processors 202 and a memory 204. The memory 204 can be a computer-readable medium. The one or more processors 202 may include any suitable single-core or multi-core processor. For example, the one or more processors 202 can be an application processor (AP), a digital-signal processor (DSP), a central processing unit (CPU), or a graphics processing unit (GPU). The one or more processors 202 may be configured to execute instructions or commands stored within the memory 204. The memory 204 may be stored within one or more non-transitory storage devices. The one or more non-transitory storage devices can include a random access memory (RAM), a dynamic RAM (DRAM), a non-volatile RAM (NVRAM), or a static RAM (SRAM). The one or more non-transitory storage devices can include a read-only memory (ROM), a flash memory, a hard drive, or a solid-state drive (SSD). The one or more non-transitory storage devices can be any type of media suitable for storing electronic instructions. Each of the one or more non-transitory storage devices can be coupled with a computer system bus. The term “coupled” may refer to two or more elements that are in direct contact. The direct contact can be physical, electrical, magnetic, optical, etc. The term “coupled” may refer to two or more elements that are not in direct contact with each other but still cooperate and/or interact with each other.

The memory 204, in some examples, includes instructions 206. The instructions 206 can be in the form of executable code. The instructions 206 can include one or more applications, software, etc. In some examples, the memory 204 further includes a cache 208. According to some examples, the cache 208 is a virtual memory partition of the memory 204. In some examples, the cache 208 is a physical partition of the memory 204.

The electronic device 102 includes, in some examples, one or more modules 210. The one or more modules 210 can, in aspects, be based on one or more capabilities of the electronic device 102. Examples of the one or more modules 210 include one or more sensor modules 212, one or more input modules 214, one or more communication modules 216, and/or one or more other modules 218. The one or more sensor modules 212 may include input sensors, capacitive sensors, infrared sensors, optical sensors, and/or a microphone or a camera to receive a multimodal input. The multimodal input can include an audio input, an image input, or a video input. Data based on any one of the one or more sensor modules 212 may be used in parsing an input. The input can be the prompt input 104 of FIG. 1. The data may be used as a basis for a generated output. The output can be the response 106 of FIG. 1. The data may be used as an action for the output, as the input or a part of the input, or as any other aspect of virtual batches in non-causal large language model inferences. Similarly, data based on any one of the one or more input modules 214 may be used in parsing an input. The input can be the prompt input 104. The data may be used as a basis for a generated output. The output can be the response 106. The data may be used as an action for the output, as the input or a part of the input, or as any other aspect of virtual batches in non-causal large language model inferences.

The one or more communication modules 216 may include wired or wireless connection interfaces, radios, connection protocols, etc. The one or more other modules 218 may include other aspects of the electronic device 102 not shown for clarity. The other aspects can include a screen, a microphone, or other capabilities of the electronic device 102. The one or more communication modules 216, the one or more other modules 218, or both may also be used in parsing an input. The input can be the prompt input 104. The modules can be used as a basis for a generated output. The output can be the response 106. The modules can be used as an action for the output, as a basis for the input or a part of the input, or as any other aspect of virtual batches in non-causal large language model inferences. The one or more communication modules 216 may enable communication of device data. The device data can include received data, transmitted data, or other information as described herein. The communication modules 216 may provide connectivity to one or more networks and other devices connected therewith.

Examples of the one or more communication modules 216 include near field communications (NFC) transceivers and wireless personal area network (WPAN) radios. The WPAN radios can be compliant with various IEEE 802.15 (Bluetooth®) standards. The communication modules 216 can include wireless local area network (WLAN) radios. The WLAN radios can be compliant with any of various IEEE 802.11 (WiFi®) standards. The communication modules 216 can include wireless wide area network (WWAN) radios for cellular telephony. The WWAN radios can be 3GPP-compliant. The communication modules 216 can include wireless metropolitan area network (WMAN) radios. The WMAN radios can be compliant with various IEEE 802.16 (WiMAX®) standards. The communication modules 216 can include infrared (IR) transceivers. The IR transceivers can be compliant with an Infrared Data Association (IrDA) protocol. The communication modules 216 can include wired local area network (LAN) Ethernet transceivers. Device data communicated over the one or more communication modules 216 may be packetized or framed depending on a communication protocol or standard by which the electronic device 102 is communicating. The one or more communication modules 216 may include interfaces for communication over a local network, a private network, or an intranet. The interfaces can enable communication over the Internet or wireless networks. The wireless networks can include WLANs, cellular networks, or WPANs.

The electronic device 102 may further include and/or be operatively coupled to an LLM 222. For example, the LLM 222 may be stored on the memory 204. The LLM 222 can be stored as part of the instructions 206. In another example, the LLM 222 is stored remote from the electronic device 102 and is accessed via the one or more communication modules 216. The LLM 222 includes one or more of parameters 224, a language space 226, and machine-learned (ML) models 228. The LLM 222 can include fine-tuning (FT) 230, one or more action modules 232, and one or more interface modules 234. The LLM 222 can also include an encoder. The encoder can be a bidirectional transformer. The encoder can process a multimodal input to generate a prefix sequence or a portion of a prefix sequence. The prefix sequence can include a plurality of soft tokens. The LLM 222 can additionally include a feed-forward network (FFN) layer. The FFN layer can be configured to track a virtual batch relationship.

In aspects, the parameters 224 govern the behavior of the LLM 222. For example, the LLM 222 may take a prompt as an input. The input can be the input prompt 104 of FIG. 1. The LLM 222, in aspects, can parse the input using the parameters 224 and the language space 226. In some examples, the LLM 222 also uses ML models 228 to further parse the input and/or generate the output. The ML models 228 can apply an attention mask to the prefix sequence of the input. The attention mask can include a non-causal mask portion corresponding to the prefix sequence. The non-causal mask portion can be, for example, a square attention mask. In some examples, the LLM 222 uses the FT 230. For example, the FT 230 can be used to grant a generic LLM specialized knowledge pertaining to a particular subject. As an example, the FT 230 can include user-specific data. In some examples, the FT 230 includes one or more low-rank adaptations (LoRA) or retrieval-augmented generations (RAG). The FT 230 can include other techniques known in the art for fine-tuning or otherwise modifying existing LLMs. The existing LLMs can include the LLM 222.

The one or more action modules 232 may allow the LLM 222 to execute actions. For example, if the parsing of the input indicates a desire to execute an action, the LLM 222 can use the one or more action modules 232 to execute the desired action. For example, consider a user input prompt of “cancel my meeting tomorrow.” The LLM 222 may parse the user input prompt. The parsing can use the parameters 224, the language space 226, etc. The LLM 222 can conclude that user calendar data is requested to fully parse the user input prompt and generate the output. The one or more action modules 232 may include calendar functionality from the electronic device 102. The one or more action modules 232 can provide the user calendar data to the LLM 222. The LLM 222 may further parse the user calendar data and conclude that a particular meeting is the “my meeting” referenced by the user. The one or more action modules 232 may cancel the particular meeting and provide a cancellation confirmation to the LLM 222. The LLM 222 may use the cancellation confirmation as at least a partial basis for the output. For example, the output can be of the form “I have canceled your meeting with the builder tomorrow. Is there anything else you need?”

Other actions may be accessible to the one or more action modules 232. The other actions can include vehicle controls, information retrieval, communications, and capabilities of the electronic device 102. The capabilities can include the modules 210. The other actions can be similar actions. In some examples, the one or more action modules 232 use application programming interface (API) functionality from one or more applications available to the electronic device 102 or another device. In some examples, the LLM 222 can create a new action module based on known or implied capabilities. The one or more action modules 232 listed here, including the associated actions, are examples. Other actions or action modules 232 not listed can be equally employed by the LLM 222 using the methods outlined in this disclosure.

The one or more interface modules 234, in aspects, provide for interfacing between the LLM 222 and other devices, bots, etc. For example, the LLM 222 can use the one or more interface modules 234 to connect with a different LLM that is deployed on a remote device. For example, the different LLM may have access to restricted data that the LLM 222 cannot access itself. In another example, the one or more interface modules 234 can import sensor data from the one or more sensor modules 212 of the electronic device 102. For example, the LLM 222 can, using the one or more interface modules 234, obtain a user facial expression for use as at least part of the input. The user facial expression can be based on camera data from a camera of the one or more input modules 214. The interface modules 234 can also receive the plurality of soft tokens from the encoder to interface multimodal data with a text modality of the LLM 222.

### Example Dependency Map

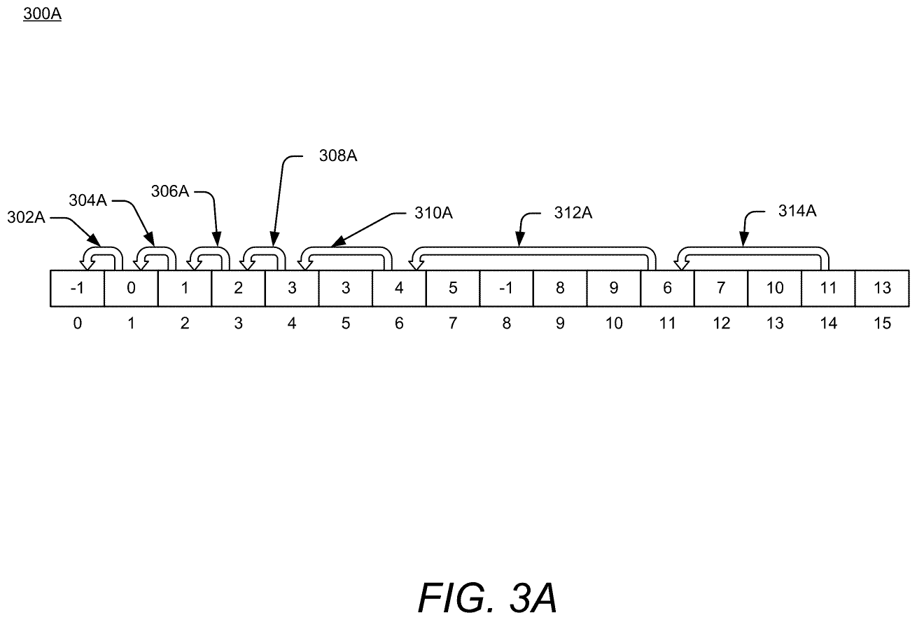

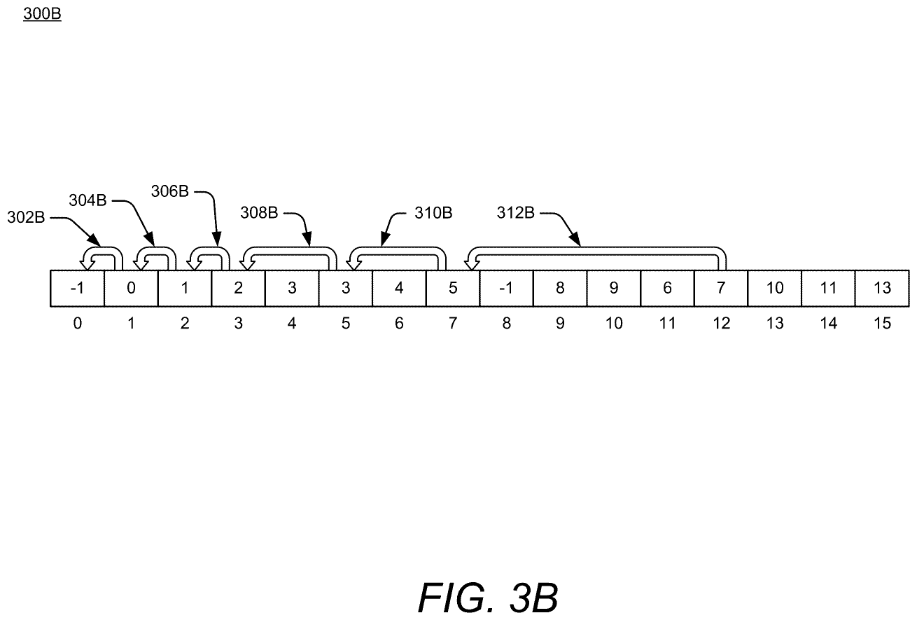

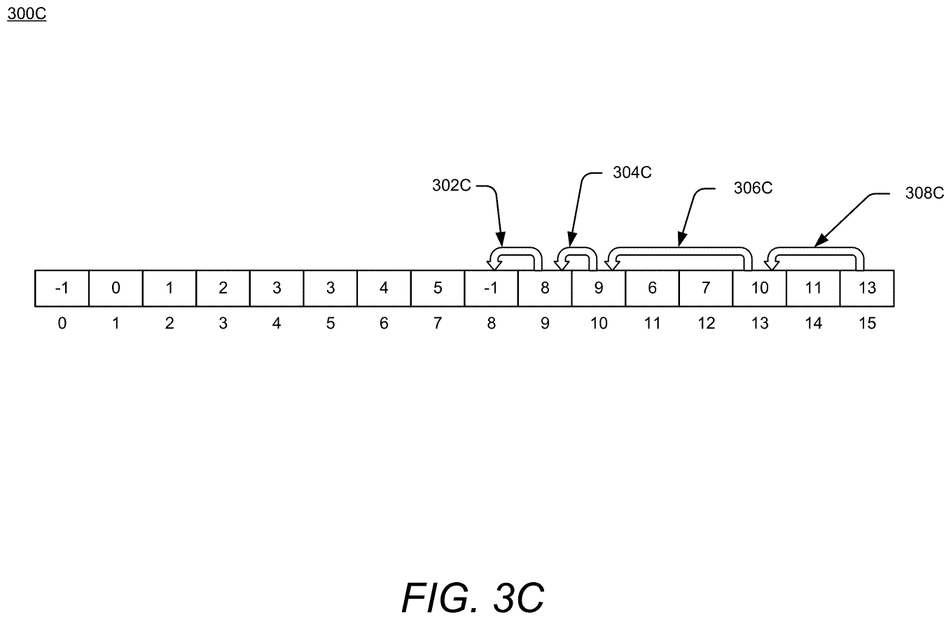

FIG. 3A illustrates an example dependency map array 300A. The dependency map array 300A is for implementing virtual batches in non-causal large language model inferences. The dependency map array 300A has indices 0 through 15. Each index has an associated correlation value. In aspects, the indices and the correlation values can be represented by ordinal pairs. For example, the index 0 has the correlation value of −1. The index 0 and the correlation value of −1 can be represented by the ordinal pair (0, −1). The dependency map array 300A can include metadata. The metadata can indicate whether a specific index marker corresponds to a prefix sequence. The metadata can trigger an application of a non-causal mask portion.

In aspects, the dependency map array 300A maps dependencies of a plurality of tokens. The plurality of tokens can be part of an inference made by an LLM. The LLM can be the LLM 222 of FIG. 2. The dependency map array 300A can be used to generate an output from the LLM. The output can be the response 106 of FIG. 1. Each of the indices denotes where a token of the plurality of tokens is located on the dependency map array 300A. Each of the correlation values denotes the index of a preceding token to the token of the plurality of tokens. For a non-causal prefix sequence, a subset of the plurality of tokens may logically map to a common starting point.

The index 0 of the dependency array 300A includes the ordinal pair (0, −1). The −1 correlation value shows that a token indicated by index 0 has no antecedent. Though the −1 value is used in FIG. 3A to indicate that the token indicated by index 0 has no antecedent, other values or signals may be used equivalently. The use of the value −1 should be understood as illustrative, not limiting. The token indicated by index 0 is a beginning of a first virtual batch. The index 1 includes an ordinal pair (1, 0). The ordinal pair (1, 0) indicates a token indicated by the index 1 attends to the token indicated by the index 0. A first association arrow 302A shows a mapping from the index 1 to the index 0. The index 2 includes an ordinal pair (2, 1). The ordinal pair (2, 1) indicates a token indicated by the index 2 attends to the token indicated by the index 1. A second association arrow 304A shows a mapping from the index 2 to the index 1. The index 3 includes an ordinal pair (3, 2). The ordinal pair (3, 2) indicates a token indicated by the index 3 attends to the token indicated by the index 2. A third association arrow 306A shows a mapping from the index 3 to the index 2. The index 4 includes an ordinal pair (4, 3). The ordinal pair (4, 3) indicates a token indicated by the index 4 attends to the token indicated by the index 3. A fourth association arrow 308A shows a mapping from the index 4 to the index 3.

The token indicated by the index 1 is said to attend to the token indicated by the index 0. The token indicated by the index 1 can attend to other tokens in addition to the token indicated by the index 0. As used in this disclosure, attending by a first token to a second token may include the first token attending to itself. The attending may include the first token attending to any token to which the second token attends. Furthermore, the attending may include bidirectional attention. For example, tokens within a prefix sequence can each attend to every other token of the prefix sequence. For example, the second token can attend to a third token. The third token can attend to a fourth token. The first token can attend to one or more of the first, second, third, and fourth tokens. An association arrow indicates the attending of one token to another. For example, the first association arrow 302A shows the token indicated by the index 1 attends to the token indicated by the index 0.

The index 6 has an ordinal pair (6, 4). The ordinal pair (6, 4) indicates a token associated with the index 6 attends to the token associated with the index 4. This attendance is shown by a fifth association arrow 310A. Similarly, the index 11 has an ordinal pair (11, 6). The ordinal pair (11, 6) indicates a token associated with the index 11 attends to the token associated with the index 6. This attendance is shown by a sixth association arrow 312A. Similarly, the index 14 has an ordinal pair (14, 11). The ordinal pair (14, 11) indicates a token associated with the index 14 attends to the token associated with the index 11. This attendance is shown by a seventh association arrow 314A. A first ordered set of attending tokens is {0, 1, 2, 3, 4, 6, 11, 14}. The first ordered set can be a first terminal chain of tokens. For example, the first terminal chain of tokens can be a complete first virtual batch. In other examples, the first ordered set is part of an incomplete first virtual batch. The incomplete first virtual batch has future tokens. The future tokens will attend to a token associated with the index 14.

FIG. 3B shows a virtual batch mapping using a dependency array 300B. The dependency array 300B is the same as the dependency array 300A of FIG. 3A. A different virtual batch path is shown in FIG. 3B. As in the example of FIG. 3A, the index 0 includes an ordinal pair (0, −1). The index 1 includes an ordinal pair (1, 0). The ordinal pair (1, 0) indicates a token indicated by the index 1 attends to the token indicated by the index 0. A first association arrow 302B shows a mapping from the index 1 to the index 0. A second association arrow 304B shows a mapping from the index 2 to the index 1. A third association arrow 306B shows a mapping from the index 3 to the index 2.

The index 5 has the correlation value 3. The index 5 has an ordinal pair (5, 3). A fourth association arrow 308B shows a mapping from the index 5 to the index 3. The index 7 has an ordinal pair (7, 5). The ordinal pair (7, 5) indicates a token associated with the index 7 attends to the token associated with the index 5. This attendance is shown by a fifth association arrow 310B. Similarly, the index 12 has an ordinal pair (12, 7). The ordinal pair (12, 7) indicates a token associated with the index 12 attends to the token associated with the index 7. This attendance is shown by a sixth association arrow 312B. A second ordered set of attending tokens is {0, 1, 2, 3, 5, 7, 12m}. The second ordered set can be a second terminal chain of tokens. For example, the second terminal chain of tokens can be a complete second virtual batch. In other examples, the second ordered set is part of an incomplete second virtual batch. The incomplete second virtual batch has future tokens. The future tokens will attend to the token associated with the index 12.

Consider the first ordered set of FIG. 3A and the second ordered set. Both have a same prefix. The same prefix is {0, 1, 2, 3}. The same prefix can be a prefix sequence. The prefix sequence can be processed simultaneously using a non-causal mask portion. The non-causal mask portion can be, for example, a square attention mask. It is possible for two or more virtual batches to share the same prefix. In other examples, two or more virtual batches can share a same portion. The same portion can be a middle portion, a terminal portion, or any combination of portions. The generation of virtual batches using a dependency map allows for a smaller storage and computational footprint than physical batching. The dependency map can be the dependency array 300B, the dependency array 300A of FIG. 3A, etc.

FIG. 3C shows a virtual batch mapping using a dependency array 300C. The dependency array 300C is the same as the dependency array 300A of FIG. 3A and the dependency array 300B of FIG. 3B. A different virtual batch path is shown in FIG. 3C. The index 8 includes an ordinal pair (8, −1). The ordinal pair (8, −1) indicates the token associated with the index 8 does not attend to any other token associated with the dependency array 300C. Another token not indicated by the dependency array 300C can be of the same form as one or more of the plurality of tokens. The same form is incidental. The same form is not part of the logical construct of the dependency array 300C. The token associated with index 8 can represent a beginning of a second prefix sequence for a second unrelated workload. The second prefix sequence can be interleaved with the first prefix sequence. The index 9 includes an ordinal pair (9, 8). The ordinal pair (9, 8) indicates a token indicated by the index 9 attends to the token indicated by the index 8. A first association arrow 302C shows a mapping from the index 9 to the index 8. A second association arrow 304C shows a mapping from the index 10 to the index 9. A third association arrow 306C shows a mapping from the index 13 to the index 10. A fourth association arrow 308C shows a mapping from the index 15 to the index 13.

A third ordered set of attending tokens is {8, 9, 10, 13, 15}. The third ordered set can be a third terminal chain of tokens. For example, the third ordered set can be a complete third virtual batch. In other examples, the third ordered set is part of an incomplete third virtual batch. The incomplete third virtual batch has future tokens. The future tokens will attend to a token associated with the index 15. The third ordered set does not attend to any of the tokens associated with the first ordered set in the example of FIG. 3A. The third ordered set does not attend to any of the tokens associated with the second ordered set in the example of FIG. 3B. This lack of attendance is other than incidentally should two tokens happen to have the same form. The third ordered set can represent an interleaved workload. The interleaved workload can be processed in parallel with the first ordered set. The third ordered set can include a second prefix sequence. The second prefix sequence can be processed with a respective non-causal mask portion.

A dependency map is illustrated in FIGS. 3A, 3B, and 3C as an array of ordinal pairs. The dependency map is in the form of the dependency map array 300A of FIG. 3A, the dependency array 300B of FIG. 3B, and/or the dependency array 300C of FIG. 3C. This illustration is an example. The dependency map can equivalently be a 1-dimensional array of single values. The indices can be implicit in the 1-dimensional array. The dependency map can be a matrix of greater-than-two-dimensional correlations. For example, the matrix can use triplets. The dependency map arrays 300A, 300B, and 300C are examples used for ease of illustrating the concept of the dependency map. The dependency map can be ordered. An order of the dependency map does not dictate a corresponding order in a memory where the dependency map is stored. For example, the memory can be a key-value (KV) cache.

In some aspects, the dependency map is further configured to determine a mathematical position of each token within its respective true sequence (e.g., its isolated logical inference path). Because a plurality of virtual batches or workloads may be interleaved or otherwise arranged non-contiguously within a shared physical memory space (e.g., a KV cache), a physical index slot for a given token may diverge from a chronological position in an independent timeline of the given token. By tracing token relationships back through the correlation markers of the dependency map to a common starting point or root antecedent, the system may dynamically extrapolate a sequence-specific position index for each token. This sequence-specific position index may provide a correct mathematical position required to compute precise position embeddings (e.g., rotary position embeddings (RoPE)), which can allow attention distance calculations to remain structurally accurate across deep layers of the LLM despite physical interleaving or other out-of-order storage in memory.

### Example Virtual Batches

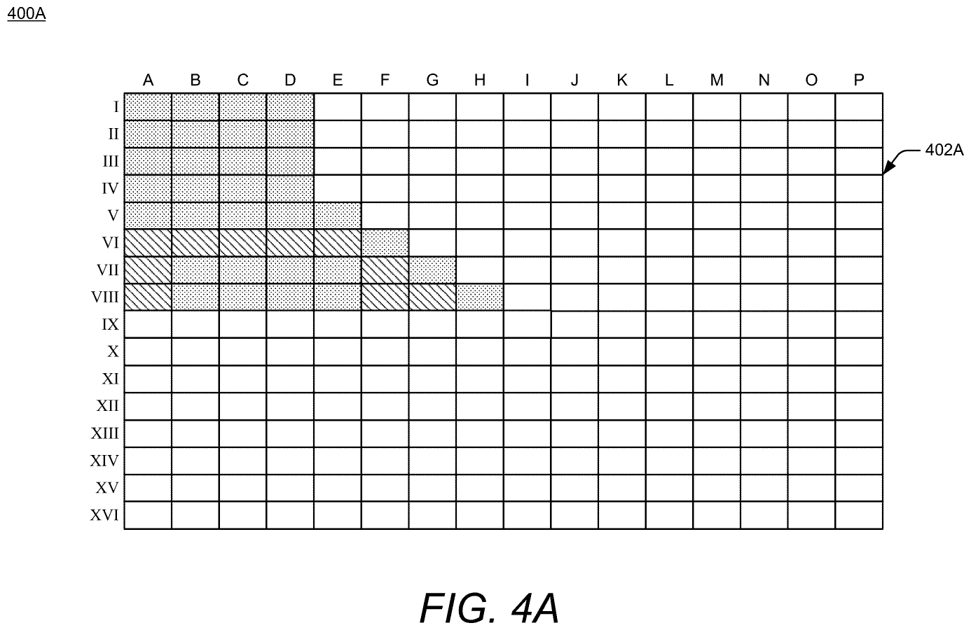

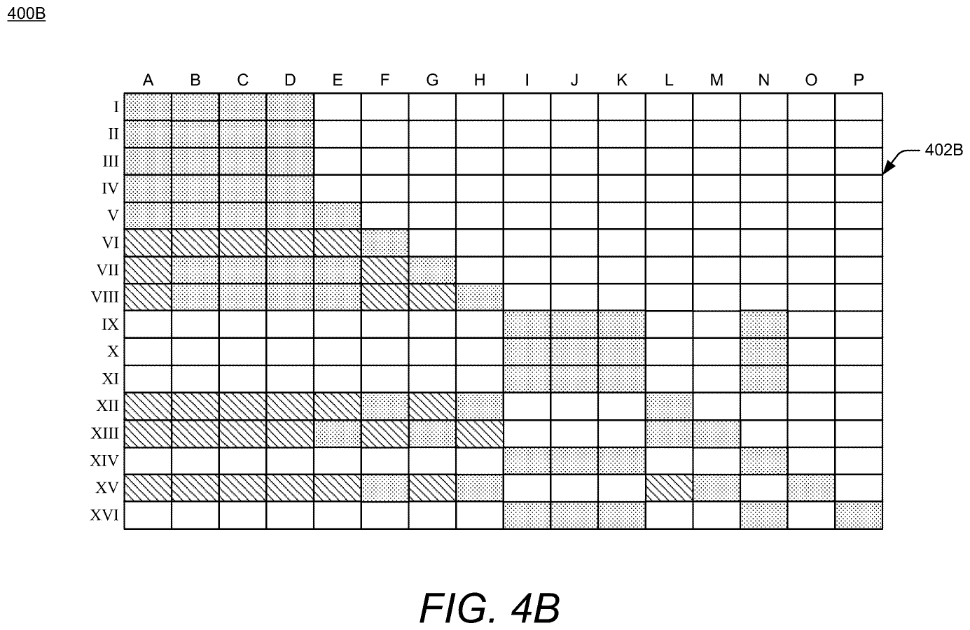

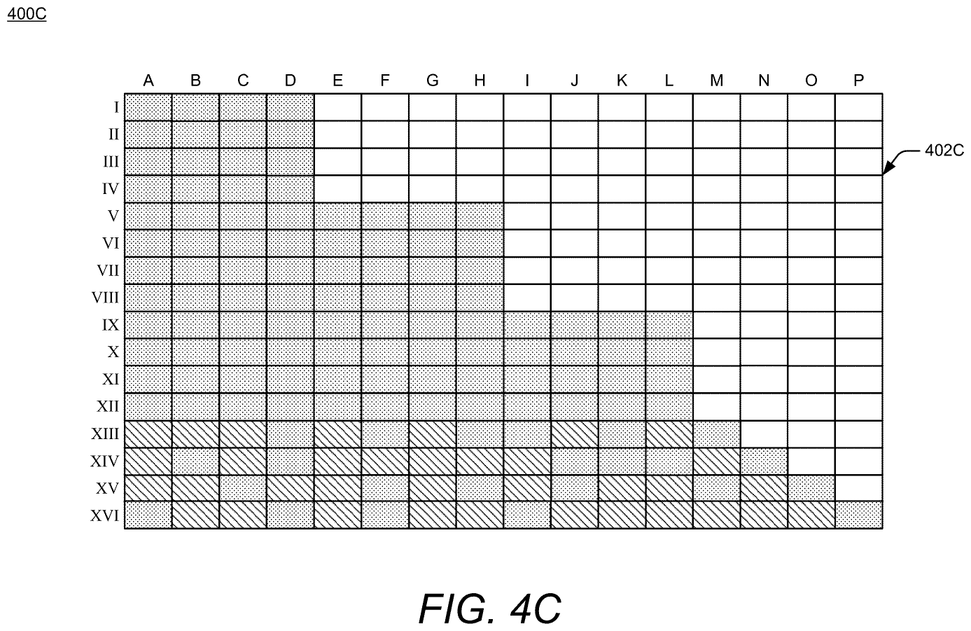

FIGS. 4A-4C illustrate example virtual batch generations 400A-400C with masking. The virtual batch generations 400A-400C can be generated from a dependency map, such as the dependency map arrays 300A-300C of FIGS. 3A-3C. A dependency map can also be generated from the virtual batch generations 400A-400C. The virtual batch generations 400A-400C may be generated implicitly from the dependency map without the creation of any physical batches. In some examples, the virtual batches themselves can be logical consequences and need not be physically constructed in order to fully include all virtual batches.

The example virtual batch generations 400A-400C may suggest a sequential row generation order for ease of understanding. It should be understood, however, that any row shown in any of the virtual batch generations 400A-400C may be generated in any order. Other numbers of simultaneous row generations may equally be used, such as 16 rows, 32 rows, or a single row at a time.

FIG. 4A illustrates the example virtual batch generation 400A on a grid 402A. The grid 402A is marked by alphabetical columns A through P and Roman numerical rows I through XVI. The columns A through P correspond to indices 0 through 15 of a dependency map (e.g., the dependency map array 300 of FIG. 3). Rows and columns of the grid 402A are referred to by a coordinate pair, such as a coordinate pair (I, A) for row I and column A.

The virtual batch generation 400A includes a non-causal mask portion corresponding to a prefix sequence, which occupies rows I through IV and columns A through D. The cells corresponding to these rows and columns are shaded in a stippled pattern to indicate active cells forming a square attention mask. This square attention mask configures each token of the prefix sequence to attend to every other token of the prefix sequence.

The attention mask of the virtual batch generation 400A further includes a causal mask portion. The causal mask portion corresponds to one or more subsequent tokens generated auto-regressively after the prefix sequence. The causal mask portion forms a triangular attention mask starting at row V. For example, row V includes active cells at columns A through E, and row VI includes active cells at columns A through F. The active cells in the causal mask portion are shaded with a stippled pattern and masked tokens are indicated by diagonal lines. Additionally, the grid 402A includes one or more blank cells, which indicate the corresponding positions lack an active token reference for a respective virtual batch. In aspects, these blank cells can be understood as masked cells.

FIG. 4B illustrates the example virtual batch generation 400B. The virtual batch generation 400B includes a grid 402B, which illustrates an interleaving of a plurality of workloads. A first workload of the plurality of workloads includes a first prefix sequence with non-causal decoding shown in rows I through IV. These rows are identical to the rows I-IV of the grid 402A of FIG. 4A.

A second workload of the plurality of workloads includes a causal decode sequence, illustrated in rows V-VIII, XII, XIII, and XV. In aspects, the virtual batches relating to the second workload attend to one or more portions of the first workload. Though the rows of the second workload are non-contiguous, their attention mask, as indicated by the stippled and diagonal line patterns, gives a logical, cohesive mapping.

A third workload of the plurality of workloads includes a second prefix sequence utilizing tokens corresponding to columns I, J, K, and N. The second prefix sequence is processed in rows IX-XI and XIV. The cells for these intersecting rows and columns are shaded with the stippled pattern to indicate active cells. This creates a split square attention mask, allowing the tokens of the second prefix sequence to bidirectionally attend to one another while sharing the grid 402B with the first workload.

Columns A through H are blank for rows IX-XI and XIV of the grid 402B. These blank cells represent non-active positions that functionally mask the second workload to prevent the third workload from incorrectly attending to it. Intermediate columns within the third workload's span, such as columns L and M, are also blank in the rows pertaining to the third workload as they belong to a different sequence.

The second workload continues causal decoding in rows XII-XIII and XV, which logically skip over the interleaved tokens of the third workload. The tokens of the second workload attend back to specific ancestral chains using active cells shaded with the stippled pattern, while masked tokens are indicated by the diagonal striped pattern. Specifically, row XII includes masked cells at columns A, B, C, D, E, and G. To prevent cross-contamination, the skipped intermediate tokens in row XII (e.g., cell (XII, J)) may be indicated as masked cells even without the diagonal striped pattern. Active attention cells are again indicated with the stippled pattern.

Row XIII similarly includes active cells shaded with the stippled pattern at columns E, G, L, and M. The diagonal striped pattern indicates masked tokens for row XIII at columns A-D, F, and H. Row XV includes active cells at columns F, H, L, and O. The remaining intermediate columns before column O are shaded with the diagonal striped pattern to indicate they are explicitly masked cells or are left blank.

A fourth workload initiates causal decoding in row XVI. Row XVI includes active cells shaded with the stippled pattern at columns I, J, K, N, and P. This allows the token at row XVI to attend to the second prefix sequence and itself. Intermediate columns between the active cells of the second workload in row XVI are left blank, functionally indicating masked or otherwise inactive cells. For example, columns L, M, and O are inactive and/or masked. By visually isolating the active and masked cells for each discrete token sequence, the grid 402B illustrates interleaving a plurality of workloads on a shared physical grid 402B. This interleaving preserves a logical token relationship based on the dependency map without cross-contamination.

FIG. 4C illustrates the example virtual batch generation 400C. The virtual batch generation 400C includes a grid 402C illustrating a hybrid prefix language model architecture. A massive prefix sequence can be processed in a plurality of chunks to mitigate a computational memory constraint associated with prefix language models. A respective non-causal mask portion is applied to each chunk of the plurality of chunks to manage the computational load.

A first chunk occupies rows I through IV and columns A through D. A second chunk occupies rows V through VIII and columns A through H. A third chunk occupies rows IX through XII and columns A through L. The active cells for these respective non-causal mask portions are shaded with the stippled pattern. The tokens within each chunk attend bidirectionally to each other while also attending to all tokens in the preceding chunks. This forms a respective solid square or rectangular active mask for each chunk. The remaining cells outside the active sequence in these rows are blank to represent non-active positions.

The virtual batch generation 400C transitions to an auto-regressive decoding phase after the chunked prefix sequence is complete. Rows XIII through XVI illustrate a transition to a triangular causal mask portion. The tokens in this auto-regressive decoding phase can attend to the entire prefix sequence and any preceding decode steps.

For example, row XIII includes active cells shaded with the stippled pattern from column A continuously through column M. Row XIV includes both active and masked cells from column A continuously through column N. Rows XV and XVI follow suit, including both masked and active cells ending at columns O and P, respectively. The remaining cells beyond the active decode steps are blank to represent non-active positions. Though these cells are blank, it can be understood, in some examples, that the blank cells are equivalent to masked cells (e.g., an initialized but unworked cell may have its value actively masked from any token attending to it).

### Large Language Models (LLMs)

Generally, LLMs are a class of artificial intelligence (AI). LLMs (e.g., the LLM 222 of FIG. 2) are trained on enormous amounts of data to provide foundational capabilities, which can be used and reused, often through fine-tuning for particular applications and tasks. Other software applications, in contrast, are often built and trained on specific data for each individual use case. In this way, LLMs may act as a type of foundational model.

Some LLMs use a machine-learned (ML) computer model capable of parsing language and providing context-aware outputs. These context-aware outputs can, for example, mimic a human response. This mimicry of a human response is typically provided in reply to a prompt, such as from a user asking a question. For example, the phrase “ask how to get to the train station in French” can be used as an input prompt. An LLM provides a translation service based on this input, delivering a human response in the French language to the English language prompt.

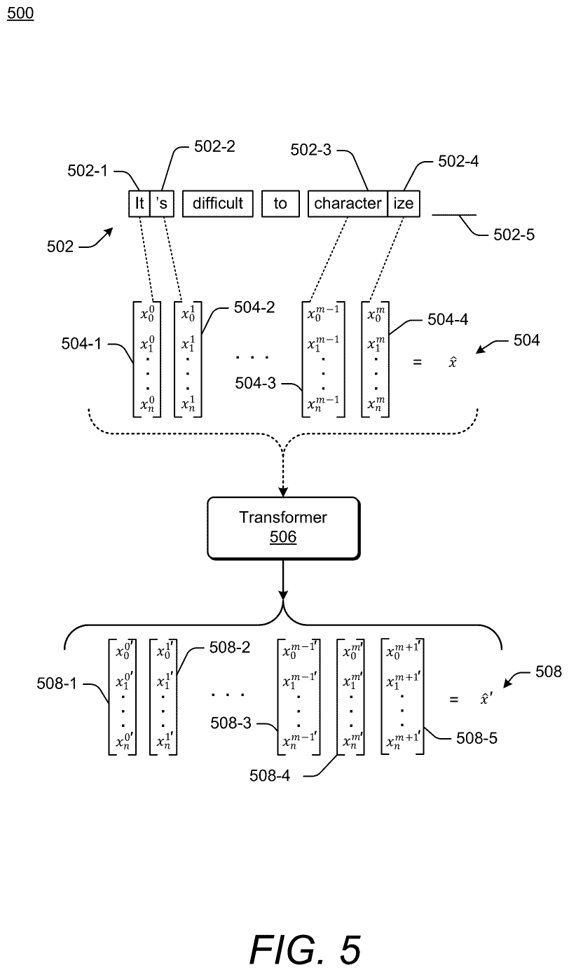

By way of example, consider FIG. 5, which illustrates a trainer 500 utilized to train an LLM (e.g., the LLM 222 of FIG. 2). The trained LLM can be used for virtual batches in non-causal LLM inferences (e.g., the virtual batches 400A-400C of FIGS. 4A-4C). The trainer 500 receives training data as training inputs (e.g., an input 502). This training data may be of many different types (e.g., labeled text and prediction data). In the example illustrated by FIG. 5, the training input 502 is a phrase.

The training input 502 may alternatively be a single word, a long text passage, or any other data containing comprehensible text. For example, a long text passage can be a book, an article, or a web-page. In some examples, the text is derived from a screen or image capture. In a process called tokenization, the trainer 500 breaks the training input 502 into tokens, marked as tokens 502-1, 502-2, 502-3, and 502-4. The training input 502 has a missing next word marked as a blank 502-5. The goal of the trainer 500 may be to predict the blank 502-5.

The trainer 500 encodes the tokens (502-1, 502-2, etc.) into an input tensor \hat{x} 504 through a mapping procedure. For instance, the token “It” 502-1 is mapped to a first component 504-1 of the input tensor \hat{x} 504, the token “'s” is mapped to a second component 504-2 of the input tensor \hat{x} 504, the token “character” is mapped to a third component 504-3 of the input tensor \hat{x} 504, and the token “ize” is mapped to a fourth component 504-4 of the input tensor \hat{x} 504. Though the tokens “It” 504-1 and “'s” 504-2 are shown as two portions of the word “It's,” other mapping schemes exist (e.g., mapping based on discrete words or phonemes). In some instances, an ML model or an ML component of the trainer 500 performs the tokenization and/or mapping of the training input 502 into the input tensor \hat{x} 504 (e.g., a feature-extracting convolutional neural network (CNN)). The mapping of the tokenized training input 502 into the input tensor \hat{x} 504 may involve a lookup table, which maps each possible token (e.g., 502-1, 502-2, etc.) to a known tensor object in a language space of the training data. The mapping of the tokens 502, in some examples, is referred to as an embedding.

A transformer 506 takes the input tensor \hat{x} 504 as an input, with the goal of predicting the blank 502-5 by transforming the input tensor \hat{x} 504 into a transformed tensor \hat{x} ′ 508. The transformation process is mathematically represented as follows:

T( [symbol] )=\hat{x}′ Eq. 1

T in Eq. 1 represents the transformer 506. The transformed tensor \hat{x} ′ 508 includes components 508-1, 508-2, 508-3, 508-4, and 508-5. The component 508-1 is a transformation of the component 504-1 by the transformer 506 (similar for component pairs 508-2/504-2, 508-3/504-3, and 508-4/504-4). The component 508-5 corresponds to the blank 502-5, and thus the component 508-5 is a prediction for the blank 502-5. The final transformed tensor \hat{x} 508 component 508-5 is derived as part of the transformation process in addition to the contextualization of the components 504-1 through 504-4.

In some examples, the final transformed tensor \hat{x}′ 508 component 508-5 is multiple components. For example, a second transformed tensor \hat{x}″ (not pictured) can be generated by performing a different transformation T′ (not pictured) as follows:

T( [symbol] )=\hat{x}′ Eq. 2

A plurality of transformed tensors (e.g., the final transformed tensor \hat{x}′, the second transformed tensor \hat{x}″) may be generated. The plurality of transformed tensors (e.g., corresponding to the virtual batches 400A-400C), in some examples, can be compared by the LLM. In some instances, and based on the comparison, one or more of the plurality of transformed tensors may be selected for output.

Inputs (e.g., the input tensor \hat{x} 504 and/or the training input 502) generally include multiple tokens. For instance, the training input 502 includes the tokens 502-1 through 502-4. The trainer 500 converts a single training input (e.g., the training input 502) into multiple training inputs. For example, by removing the token 502-4, the blank 502-5 “shifts left” as the training input 502 calls for the trainer 500 to predict the token 502-4, thus creating a new training input from the original training input 502. As the value for the token 502-4 is known in this example, the new input is a labeled input, which allows it to be used by a supervised ML training algorithm. Such an input may also able to be used by an unsupervised ML training algorithm. In this way, a single text containing multiple tokens (e.g., a book, a research paper, etc.) is used as multiple training inputs for the trainer 500.

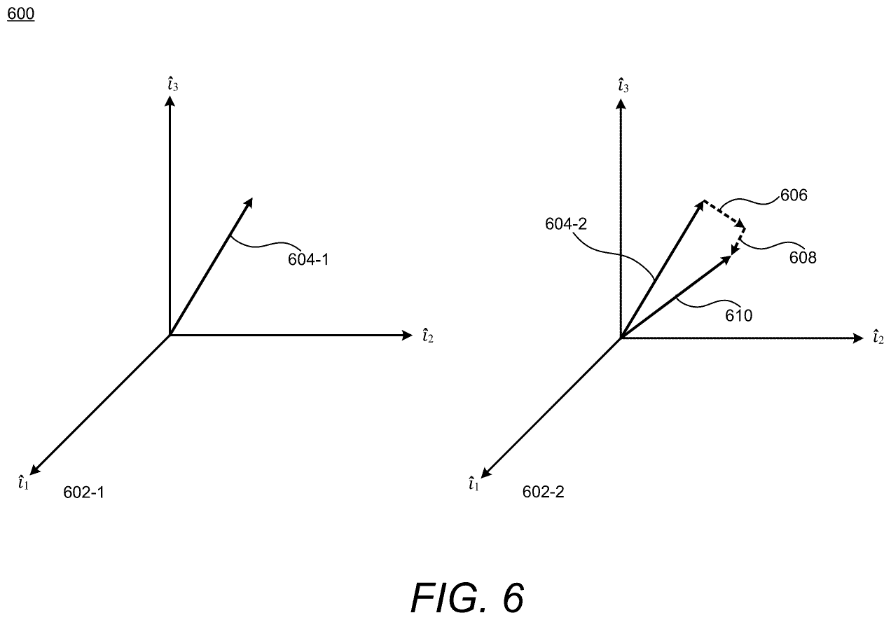

FIG. 6 illustrates an example transformation 600 in a language space 602-1 of an input tensor component 604-1 (e.g., the component 504-1 of the input tensor \hat{x} 504 of FIG. 5). The language space 602-1 is a multi-dimensional mathematical space, which includes specific language components codified as tensors within the multi-dimensional mathematical space. The term “tensor” is a mathematical object of any dimensionality, including scalar, vector, and matrix quantities. The language space 602-1 is therefore a mathematical vocabulary, and mapped tokens (e.g., token 502-1 of FIG. 5) are tokens that have been translated into the mathematical vocabulary. For ease of illustration, the language space 602-1 is shown in FIG. 6 as a three-dimensional space with orthogonal basis vectors î₁, î₂, and î₂. However, this should not be seen as limiting. In general, the language space 602-1 has the dimensionality of the mapped tokens from an input tensor. For example, the input tensor \hat{x} 504 of FIG. 5, whose tensor components 504-1 through 504-4 each contain n members, corresponds to an n-dimensional language space.

The input tensor component 604-1 is plotted in the language space 602-1, shown in FIG. 6 as a vector in three-dimensional space. In some examples, the plotting is the product of a lookup table, a CNN feature mapping, or any other mapping from a token into the language space 602-1. The input tensor component 604-1 is transformed by the transformation 600. Consider a language space 602-2, identical to the language space 602-1, and an input tensor component 604-2, identical to the input tensor component 604-1. The transformation 600 is based on transformation operators 606 and 608 and performed by a transformer. The transformation operators 606 and 608 are illustrated as vector addition operators, resulting in a remapped tensor 610.

As an illustration of this transformation, let the input tensor component 604-2 represent a mapped (e.g., translated into the mathematical vocabulary of the language space 602-2) token of “rodent” and let the transformation operators 606 and 608 be generated by contextualizing mapped tokens “large” and “eared” from an input prompt, which includes the phrase “large-eared rodent.” Contextualizing generally refers to characterizing the correlations between “rodent,” “large,” and “eared” from the input prompt (e.g., the input 502 of FIG. 5) in a way that corresponds with how a speaker of the input prompt's language would understand the word “rodent” as it appears in the input prompt along with “large” and “eared.” In this illustration, the transformed tensor 610 maps to an area of the language space 602-2 containing the word “chinchilla.”

Though the transformation of the input tensor component 604-2 to the transformed tensor 610 has been shown as two transformations using the transformation operators 606 and 608, this should not be seen as limiting. Any number of transformation operations may be employed, including more than two or a single transformation operation. Transformation operators (e.g., the transformation operator 606) may also take forms other than vector/tensor addition, including, for example, multiplication (e.g., scaling, matrix multiplication, dot product, cross product, tensor product, etc.), normalization, orthogonalization, or any combination of these or other transformation operations known to a person of ordinary skill in the art. Thus, the transformation operators 606 and 608 of FIG. 6 are meant to be illustrative, not limiting.

### Example Methods

Example methods 700 and 800 are shown as sets of blocks that specify operations performed but are not necessarily limited to the order or combinations shown for performing the operations by the respective blocks. Further, any of one or more of the operations may be repeated, combined, reorganized, or linked to provide a wide array of additional and/or alternate methods. In portions of the following discussion, reference may be made to any of the preceding figures or processes as detailed in other figures, reference to which is made for example only. The techniques are not limited to performance by one entity or multiple entities operating on one device.

Generally, any of the components, modules, methods, and operations described herein can be implemented using software, firmware, hardware (e.g., fixed logic circuitry), manual processing, or any combination thereof. Some operations of the example methods may be described in the general context of computer program products, and implementations can include software applications, programs, functions, and the like. Computer program products can include executable instructions stored on a computer-readable storage memory that is local and/or remote to a computer processing system. Alternatively or in addition, any of the functionality described herein can be performed, at least in part, by one or more hardware logic components. For example, and without limitation, hardware logic components include field-programmable gate arrays (FPGAs), application-specific integrated circuits (ASICs), application-specific standard products (ASSPs), system-on-a-chip systems (SoCs), complex programmable logic devices (CPLDs), and the like.

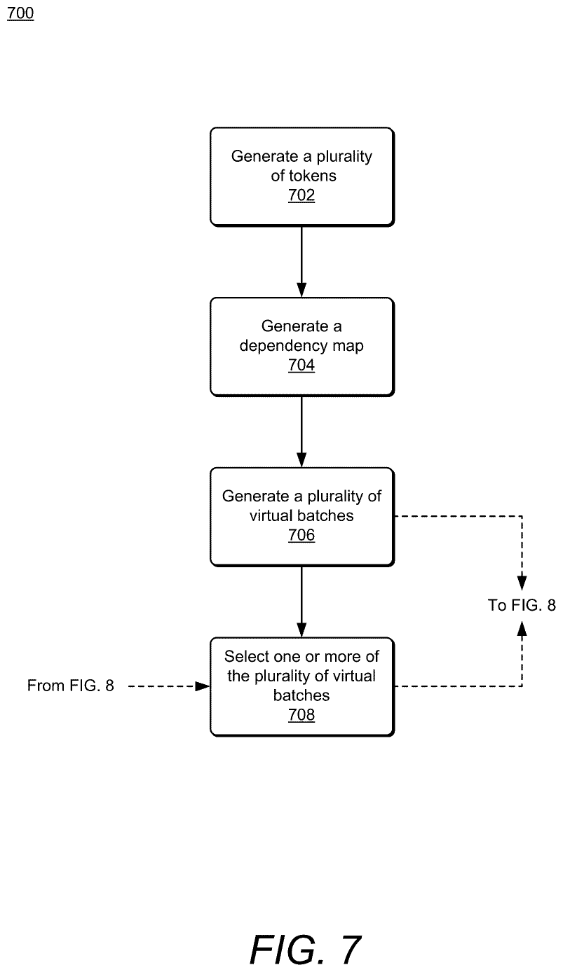

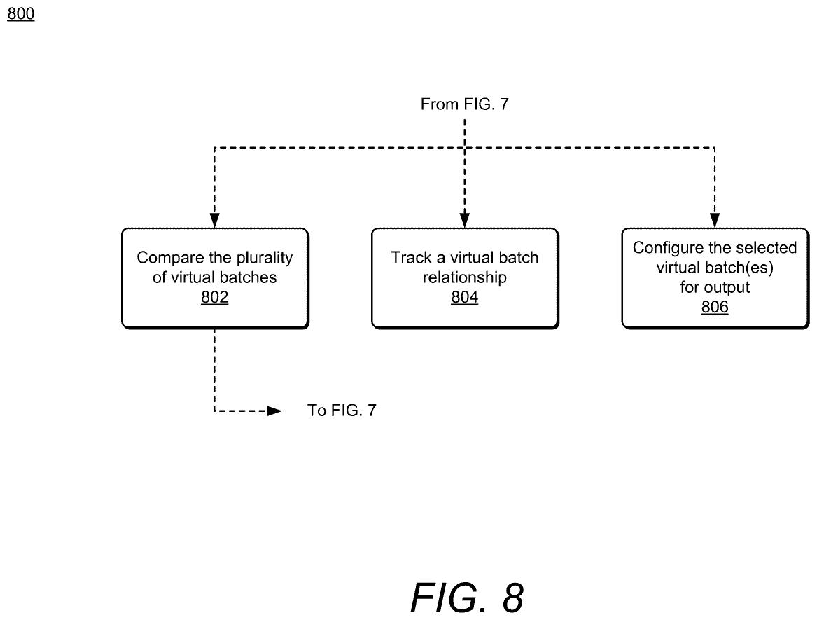

FIG. 7 illustrates the example method 700 for implementing virtual batches in non-causal large language model inferences. At 702, a plurality of tokens is generated. The plurality of tokens may be generated with an LLM. In some examples, the plurality of tokens includes a prefix sequence. The plurality of tokens can be based on one or more text inputs, one or more image inputs, one or more video inputs, one or more audio inputs, or a combination of any of these inputs.

The prefix sequence may include a plurality of soft tokens. The plurality of soft tokens can be generated by an encoder from a multimodal input. The multimodal input can include at least one of an image input, an audio input, a video input, a text input, or a robotics motion input. In some aspects, the multimodal input includes the robotics motion input. The robotics motion input may be defined by one or more joints and a spatial location of the one or more joints. The robotics motion input can be aligned into a text modality to allow processing by the LLM. The encoder may be a transformer having bidirectional attention. In some implementations, the encoder generates the plurality of soft tokens without using a convolutional neural network (CNN). The plurality of soft tokens can be high-dimensional embeddings. The LLM can logically process these embeddings alongside standard text tokens.

At 704, a dependency map is generated. The dependency map may be generated by the LLM. In some examples, the dependency map includes one or more index markers for each of the plurality of tokens. The dependency map can further include a correlation marker for each of the one or more index markers. The dependency map may be structured as a dependency array. The dependency array can be configured as ordinal pairs of the index markers and the correlation markers. For each ordinal pair, the correlation marker may be less than the corresponding index marker. In some implementations, the index markers are determined by positions of the correlation markers in the dependency array. Additionally, the dependency array can be a linear array. This linear structure can aid in the logical mapping of token sequences.

At 706, a plurality of virtual batches is generated. The plurality of virtual batches may be generated based on the dependency map. Each of the plurality of virtual batches can include a discrete inference. Generating the plurality of virtual batches may include applying an attention mask. The attention mask can include a non-causal mask portion that corresponds to the prefix sequence.

The non-causal mask portion may be configured to cause each token of the prefix sequence to attend to every other token of the prefix sequence. The non-causal mask portion can include, for example, a square attention mask. This square attention mask may correspond to the prefix sequence. The attention mask can further include a causal mask portion. This causal mask portion may correspond to one or more subsequent tokens that are generated auto-regressively after the prefix sequence.

The causal mask portion may configure the one or more subsequent tokens to attend only to itself and preceding tokens. In some instances, the causal mask portion can include a triangular attention mask. Generating the plurality of virtual batches may include processing the prefix sequence in a plurality of chunks. A respective non-causal mask portion can be applied to each chunk of the plurality of chunks. The respective non-causal mask portion may include a respective square mask for each chunk of the plurality of chunks to form a hybrid prefix language model architecture.

In other aspects, generating the plurality of virtual batches may include configuring the non-causal mask portion as a sliding lookahead window attention mask. Rather than utilizing a full all-in-one square attention mask or a series of discrete square chunks, the sliding lookahead window may define a localized attention window that progresses across the prefix sequence. This configuration may restrict an attention of one or more tokens to a predetermined number of subsequent or lookahead tokens within the prefix sequence, operating as an asymmetric local attention or sliding window attention (SWA) mechanism optimized for non-causal or bidirectional sequence contexts.

Alternatively, generating the plurality of virtual batches can include processing the prefix sequence in a single chunk. A minimum size of the single chunk may encompass all tokens of the prefix sequence simultaneously. The single chunk can encompass all tokens of the prefix sequence to satisfy a computational constraint of a prefix language model. Additionally, one or more of the plurality of virtual batches can include one or more masked markers. The one or more masked markers may be located at one or more positions in the one or more of the plurality of virtual batches. The one or more masked markers can indicate the one or more positions lack an active token reference for a respective virtual batch. This masking prevents a virtual batch from attending to an unreferenced token to avoid cross-contamination.

The plurality of virtual batches may include a single physical batch having a batch length. Alternatively, the plurality of virtual batches can include a plurality of physical batches. Each of the plurality of physical batches may have a corresponding final length. The final lengths can combine to the batch length. The batch length can be dynamic or based on a size of a cache memory. Generating the plurality of virtual batches may include deduplicating a common subsequence. The common subsequence can be shared by two or more virtual batches of the plurality of virtual batches. Two or more of the plurality of virtual batches may share a same input. The same input can include a subset of the plurality of tokens.

Generating the plurality of virtual batches may further include interleaving a plurality of workloads. The interleaving can preserve a logical token relationship based on the dependency map. In some examples, two or more of the plurality of virtual batches share a first input. One or more other virtual batches of the plurality of virtual batches can include a second input. The one or more other virtual batches may be different than any of the two or more of the plurality of virtual batches.

The first input can be different than the second input. The first input, the second input, or both may be part of a previous input or part of another virtual batch. Furthermore, a first portion of a first batch of the plurality of virtual batches can be the same as a second portion of a second batch of the plurality of virtual batches. The first batch may be different than the second batch. This allows virtual batches to efficiently branch off from a shared logical prefix.

At 708, one or more of the plurality of virtual batches is selected. The selecting may be performed by the LLM. The one or more of the plurality of virtual batches can be selected as a final inference. The selected virtual batches can be utilized to format a prediction output or inform subsequent decoding layers. The final inference may be presented to a user as a response to a prompt.

FIG. 8 illustrates the example method 800 for implementing additional aspects of virtual batches in non-causal large language model inferences. The example method 800 includes the example method 700 of FIG. 7. At 802, at least two of the plurality of virtual batches are compared. The comparison may be performed by the LLM. In some examples, the selecting of the one or more of the plurality of virtual batches as the final inference is based at least in part on the comparison. The comparing of the at least two of the plurality of virtual batches can include generating a plurality of fitness scores.

Each of the compared virtual batches may be associated with one or more of the plurality of fitness scores. These fitness scores can evaluate a confidence level for each discrete inference. The LLM can use these scores to rank the generated sequences. The highest-scoring virtual batch may be chosen as the most optimal output. This scoring system may be configured to allow for robust evaluation of parallel logical paths. In some examples, the most optimal output is surfaced to a user. In aspects, the plurality of fitness scores can be compared to one or more fitness threshold values. For example, a plurality of the discrete inferences associated with a corresponding plurality of fitness scores exceeding the one or more fitness threshold values can be surfaced to the user. In another example, none of the fitness scores associated with the discrete inferences exceed the one or more fitness threshold values, in which case none of the discrete inferences are surfaced to the user.

At 804, a virtual batch relationship is tracked. The virtual batch relationship can correspond to the plurality of virtual batches for each of the plurality of tokens. The tracking may be performed through a feed-forward network (FFN) layer of the LLM. Tracking the virtual batch relationship through the FFN layer can include bundling multiple tokens together. The bundled multiple tokens may be treated as a single token.

Information can be bled across the bundled multiple tokens during a channel mixing operation at the FFN layer. Tracking this relationship through the FFN layer ensures structural continuity across deep model layers. This continuity may be configured to protect against unintentional data loss during transformations. The preservation of virtual batch relationships may allow the model to accurately trace outputs back to their respective logical sequences.

At 806, the one or more virtual batches are configured for output. The configuring may be applied to the selected one or more of the plurality of virtual batches. The output can be formatted as an application response. The output can be integrated into a multimodal user interface. This formatting prepares the data for downstream interaction. The output may ultimately be displayed on a screen or converted to audio.

Throughout this disclosure, examples are described where a computing system may analyze information associated with a user. For example, the computing system can be the electronic device 102. The information can be the input prompt 104 of FIG. 1. The input prompt 104 can include text from a messaging application. The messaging application can be an instantiated conversation application. The user may be provided with controls. The controls may allow the user to make an election regarding data collection. The election can dictate if and when systems, programs, or features described herein may enable collection of the information. The information can include a user's social network, social actions, social activities, or profession. The information can also include a user's preferences or a user's current location. The election can additionally dictate if the user is sent content or communications from a server.

The computing system can be configured to only use the information after receiving explicit permission from the user. For example, the computing system may contain private messaging data used as the information. The user may be provided with an opportunity to provide input. The input can control whether programs or features of the computing system can collect and make use of the information. Individual users may have constant control over what programs can or cannot do with the information.

Information collected may be pre-treated in one or more ways before it is transferred, stored, or otherwise used. This pre-treatment ensures personally identifiable information is removed. For example, the private messaging data can have personally identifying facets, names, or faces removed. Furthermore, to protect user privacy, the information may be encrypted or processed locally (e.g., on the electronic device 102 of FIG. 1). The user has control over whether information is collected about the user and a device of the user. The user also has control over how such information is used by the computing system or a remote computing system.

### Additional Examples

Various examples are described herein, including a first example method (example 1) that includes generating, with a large language model (LLM), a plurality of tokens. The plurality of tokens includes a prefix sequence. The method further includes generating, by the LLM, a dependency map. The dependency map includes one or more index markers for each of the plurality of tokens. The dependency map further includes a correlation marker for each of the one or more index markers. The method further includes generating, based on the dependency map, a plurality of virtual batches. Each of the plurality of virtual batches includes a discrete inference. The method further includes selecting, by the LLM, one or more of the plurality of virtual batches as a final inference.

Example 2: The method of any one of the previous examples, where generating the plurality of virtual batches includes applying an attention mask. The attention mask includes a non-causal mask portion. The non-causal mask portion corresponds to the prefix sequence.

Example 3: The method of example 2, where the non-causal mask portion is configured to cause each token of the prefix sequence to attend to every other token of the prefix sequence.

Example 4: The method of any one of examples 2 or 3, where the non-causal mask portion includes a square attention mask. The square attention mask corresponds to the prefix sequence.

Example 5: The method of any one of examples 2 to 4, where the attention mask further includes a causal mask portion. The causal mask portion corresponds to one or more subsequent tokens. The one or more subsequent tokens are generated auto-regressively after the prefix sequence.

Example 6: The method of example 5, where the causal mask portion configures the one or more subsequent tokens to attend only to itself and preceding tokens.

Example 7: The method of any one of examples 5 or 6, where the causal mask portion includes a triangular attention mask.

Example 8: The method of any one of the previous examples, where the dependency map is a dependency array. The dependency array is configured as ordinal pairs of the index markers and the correlation markers. For each ordinal pair, the correlation marker is less than the corresponding index marker.

Example 9: The method of example 8, where the index markers are determined by positions of the correlation markers in the dependency array.

Example 10: The method of any one of examples 8 or 9, where the dependency array is a linear array.

Example 11: The method of any one of the previous examples, where the plurality of virtual batches includes a single physical batch. The single physical batch has a batch length.

Example 12: The method of any one of examples 1 to 10, where the plurality of virtual batches includes a plurality of physical batches. Each of the plurality of physical batches has a final length. The final lengths combine to a batch length.

Example 13: The method of any one of examples 11 or 12, where the batch length is based on a size of a cache memory.

Example 14: The method of any one of examples 11 or 12, where the batch length is dynamic.

Example 15: The method of any one of the previous examples, where one or more of the plurality of virtual batches includes one or more masked markers. The one or more masked markers are located at one or more positions in the one or more of the plurality of virtual batches. The one or more masked markers indicate the one or more positions lack an active token reference for a respective virtual batch.

Example 16: The method of any one of the previous examples, further including comparing, by the LLM, at least two virtual batches of the plurality of virtual batches. The selecting of the one or more of the plurality of virtual batches as the final inference is based at least in part on the comparison.

Example 17: The method of example 16, where the comparing of the at least two virtual batches includes generating a plurality of fitness scores. Each of the compared virtual batches is associated with one or more of the plurality of fitness scores.

Example 18: The method of any one of the previous examples, further including tracking a virtual batch relationship. The virtual batch relationship corresponds to the plurality of virtual batches for each of the plurality of tokens. The tracking is performed through a feed-forward network (FFN) layer of the LLM.

Example 19: The method of example 18, where tracking the virtual batch relationship through the FFN layer includes bundling multiple tokens together. The bundled multiple tokens are treated as a single token. Information is bled across the bundled multiple tokens during a channel mixing operation at the FFN layer.

Example 20: The method of any one of the previous examples, where two or more of the plurality of virtual batches share a same input. The same input includes a subset of the plurality of tokens.

Example 21: The method of any one of the previous examples, where the plurality of tokens are based on one or more text inputs, one or more image inputs, one or more video inputs, one or more audio inputs, or a combination of any of these inputs.

Example 22: The method of any one of the previous examples, where two or more of the plurality of virtual batches share a first input. One or more other virtual batches of the plurality of virtual batches include a second input. The one or more other virtual batches are different than any of the two or more of the plurality of virtual batches. The first input is different than the second input.

Example 23: The method of example 22, where the first input, the second input, or both are part of a previous input or part of another virtual batch.

Example 24: The method of any one of the previous examples, where a first portion of a first batch of the plurality of virtual batches is the same as a second portion of a second batch of the plurality of virtual batches. The first batch is different than the second batch.

Example 25: The method of any one of the previous examples, where the prefix sequence includes a plurality of soft tokens. The plurality of soft tokens are generated by an encoder from a multimodal input.

Example 26: The method of example 25, where the multimodal input includes at least one of an image input, an audio input, a video input, a text input, or a robotics motion input.

Example 27: The method of any one of examples 25 or 26, where the multimodal input includes a robotics motion input. The robotics motion input is defined by one or more joints and a spatial location of the one or more joints. The robotics motion input is aligned into a text modality.

Example 28: The method of any one of examples 25 to 27, where the encoder is a transformer having bidirectional attention. The encoder generates the plurality of soft tokens without using a convolutional neural network (CNN). The plurality of soft tokens are high-dimensional embeddings.

Example 29: The method of any one of the previous examples, where generating the plurality of virtual batches includes processing the prefix sequence in a plurality of chunks. A respective non-causal mask portion is applied to each chunk of the plurality of chunks. The respective non-causal mask portion includes a respective square mask for each chunk of the plurality of chunks. The respective square masks form a hybrid prefix language model architecture.

Example 29a: The method of any one of the previous examples, where generating the plurality of virtual batches includes applying a non-causal mask portion configured as a sliding lookahead window attention mask. The sliding lookahead window attention mask restricts token attention to a localized window of subsequent tokens within the prefix sequence.

Example 30: The method of any one of the previous examples, where generating the plurality of virtual batches includes processing the prefix sequence in a single chunk. A minimum size of the single chunk encompasses all tokens of the prefix sequence simultaneously. The single chunk encompasses all tokens of the prefix sequence to satisfy a computational constraint of a prefix language model.

Example 31: The method of any one of the previous examples, where generating the plurality of virtual batches includes deduplicating a common subsequence. The common subsequence is shared by two or more virtual batches of the plurality of virtual batches.

Example 32: The method of any one of the previous examples, where generating the plurality of virtual batches includes interleaving a plurality of workloads. The interleaving preserves a logical token relationship based on the dependency map.

Example 33: The method of any one of the previous examples, further including configuring the selected one or more of the plurality of virtual batches for output.

Example 34: The method of example 18, where the tracking the virtual batch relationship through the FFN layer includes bundling multiple tokens together. The bundled multiple tokens are treated as a single token.

Example 35: The method of any one of the previous examples, where generating the plurality of virtual batches includes interleaving a plurality of workloads. The plurality of workloads includes a first workload including the prefix sequence and a second workload including a second prefix sequence.

Example 36: The method of example 35, where the first workload and the second workload are processed simultaneously. The second prefix sequence is configured to attend only to itself.

Example 37: A method including generating, with a large language model (LLM), a plurality of tokens including a prefix sequence associated with a first workload, and a second sequence associated with a second unrelated workload. The method further includes generating, by the LLM, a dependency map. The dependency map includes one or more index markers for each of the plurality of tokens and a correlation marker for each of the one or more index markers. The method further includes generating, based on the dependency map, a plurality of virtual batches occupying a single physical batch in a cache memory, each of the plurality of virtual batches including a discrete inference. The generating of the plurality of virtual batches includes interleaving the first workload and the second unrelated workload within the single physical batch and dynamically isolating the first workload and the second unrelated workload using one or more masked markers indicating positions in the plurality of virtual batches that lack an active token reference. The method further includes selecting, by the LLM, one or more of the plurality of virtual batches as a final inference.

Example 38: An electronic device including one or more processors and a memory storing instructions. The instructions, when accessed by the one or more processors, cause the one or more processors to perform the method of any one of examples 1 to 37.

Example 39: A non-transitory, computer-readable medium storing instructions. The instructions, when accessed by one or more processors, cause the one or more processors to perform the method of any one of examples 1 to 37.

Example 40: A computer program product including instructions. The instructions, when accessed by one or more processors, cause the one or more processors to execute the method of any one of examples 1 to 37.

### Conclusion

As used herein, a phrase referring to “at least one of” or “one or more of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

Although concepts of virtual batches in non-causal large language model inferences have been described in language specific to techniques and/or systems, it is to be understood that the subject of the appended claims is not necessarily limited to the specific techniques or methods described. Rather, the specific techniques and methods are disclosed as example implementations for virtual batches in non-causal large language model inferences.

What is claimed is:

1. A method comprising:
generating, with a large language model (LLM), a plurality of tokens comprising a prefix sequence;
generating, by the LLM, a dependency map comprising:
one or more index markers for each of the plurality of tokens; and
a correlation marker for each of the one or more index markers;
generating, based on the dependency map, a plurality of virtual batches, each of the plurality of virtual batches comprising a discrete inference; and
selecting, by the LLM, one or more of the plurality of virtual batches as a final inference.

2. The method of claim 1, wherein generating the plurality of virtual batches comprises applying an attention mask comprising a non-causal mask portion corresponding to the prefix sequence.

3. The method of claim 2, wherein the non-causal mask portion is configured to cause each token of the prefix sequence to attend to every other token of the prefix sequence.

4. The method of claim 3, wherein the non-causal mask portion comprises a square attention mask corresponding to the prefix sequence.

5. The method of claim 2, wherein the attention mask further comprises a causal mask portion corresponding to one or more subsequent tokens generated auto-regressively after the prefix sequence.

6. The method of claim 5, wherein the causal mask portion configures the one or more subsequent tokens to attend only to itself and preceding tokens.

7. The method of claim 1, further comprising tracking a virtual batch relationship corresponding to the plurality of virtual batches for each of the plurality of tokens through a feed-forward network (FFN) layer of the LLM.

8. The method of claim 1, wherein the prefix sequence comprises a plurality of soft tokens generated by an encoder from a multimodal input.

9. The method of claim 8, wherein the multimodal input comprises at least one of an image input, an audio input, a video input, or a robotics motion input.

10. An electronic device comprising:
one or more processors; and
a memory storing instructions, which, when accessed by the one or more processors, cause the one or more processors to:
generate, with a large language model (LLM), a plurality of tokens, wherein the plurality of tokens comprises a prefix sequence;
generate, by the LLM, a dependency map comprising:
one or more index markers for each of the plurality of tokens; and
a correlation marker for each of the one or more index markers;
generate, based on the dependency map, a plurality of virtual batches, each of the plurality of virtual batches comprising a discrete inference; and
select, by the LLM, one or more of the plurality of virtual batches as a final inference.

11. The electronic device of claim 10, wherein generating the plurality of virtual batches comprises applying an attention mask comprising a non-causal mask portion corresponding to the prefix sequence.

12. The electronic device of claim 11, wherein the non-causal mask portion configures each token of the prefix sequence to attend to every other token of the prefix sequence, and wherein the non-causal mask portion comprises a square attention mask.

13. The electronic device of claim 11, wherein the instructions to generate the plurality of virtual batches comprise instructions to process the prefix sequence in a plurality of chunks, and wherein the non-causal mask portion comprises a respective square mask for each chunk of the plurality of chunks.

14. The electronic device of claim 10, wherein the instructions further cause the one or more processors to track a virtual batch relationship corresponding to the plurality of virtual batches for each of the plurality of tokens through a feed-forward network (FFN) layer of the LLM.

15. A non-transitory, computer-readable medium storing instructions, which, when accessed by one or more processors, cause the one or more processors to:
generate, with a large language model (LLM), a plurality of tokens, wherein the plurality of tokens comprises a prefix sequence;
generate, by the LLM, a dependency map comprising:
one or more index markers for each of the plurality of tokens; and
a correlation marker for each of the one or more index markers;
generate, based on the dependency map, a plurality of virtual batches, each of the plurality of virtual batches comprising a discrete inference; and
select, by the LLM, one or more of the plurality of virtual batches as a final inference.

16. The non-transitory, computer-readable medium of claim 15, wherein generating the plurality of virtual batches comprises applying an attention mask comprising a non-causal mask portion corresponding to the prefix sequence.

17. The non-transitory, computer-readable medium of claim 16, wherein the non-causal mask portion configures each token of the prefix sequence to attend to every other token of the prefix sequence, and wherein the non-causal mask portion comprises a square attention mask.

18. The non-transitory, computer-readable medium of claim 17, wherein the attention mask further comprises a triangular causal mask portion corresponding to one or more subsequent tokens generated auto-regressively after the prefix sequence.

19. The non-transitory, computer-readable medium of claim 15, wherein the instructions to generate the plurality of virtual batches comprise instructions to process the prefix sequence in a plurality of chunks, and wherein the non-causal mask portion comprises a respective square mask for each chunk of the plurality of chunks.

20. The non-transitory, computer-readable medium of claim 15, wherein the instructions further cause the one or more processors to track a virtual batch relationship corresponding to the plurality of virtual batches for each of the plurality of tokens through a feed-forward network (FFN) layer of the LLM.
